(19) United States
(12) Patent Application Publication
(10) Pub. No.: US 2011/0231529 A1
(43) Pub. Date: Sep. 22, 2011

(54) System and Method for Assessing a Distributor of Correspondence

(76) Inventors: Andrew S. Yates, London (GB); Mark C. Pritchard, London (GB)

(21) Appl. No.: 13/049,830

(22) Filed: Mar. 16, 2011

(30) Foreign Application Priority Data
Mar. 16, 2010 (GB) GB1004397.4

(51) Int. Cl. G06F 15/173; G06F 15/177

(52) U.S. Cl. 709/220; 709/224

(57) ABSTRACT

A method of assessing a distributor of correspondence, comprising providing a unique address for receiving correspondence from the distributor; receiving an evaluation of the distributor based on the correspondence received at the unique address; and forming an assessment of the distributor based on the received evaluation.

### CROSS-REFERENCES TO RELATED APPLICATIONS

This is a U.S. patent application taking priority from GB1004397.4 dated Mar. 16, 2010, which is incorporated herein by reference.

### BACKGROUND OF THE INVENTION

In recent years, exchanges of information, particularly those driven by marketing and advertising, have enjoyed a great deal of growth; thanks in part to the development of new and cheaper means of communication, and the ease with which such means may be employed to disseminate correspondence from distributors to prospective recipients.

For the most part, consumers and citizens alike have a desire to receive correspondence from certain distributors, particularly shops, business, societies, social clubs, institutions of governance and so on, in which they have an interest. Accordingly, it has become commonplace for distributors such as these to establish a system for discovering and storing contact information of prospective recipients such that correspondence may be sent to them. Typically, a prospective recipient would be asked by a distributor whether they would like to receive correspondence from that distributor and/or other distributors. In other cases, a prospective recipient might approach the distributor directly and request to receive communications from that distributor and/or other distributors.

In most cases, it is necessary for the prospective recipient to provide contact details to allow the distributors to send correspondence to them. In other, limited, cases, a recipient's contact details might be available unless the recipient specifically requests for them to be withheld.

Databases of contact details are very valuable to third parties, particularly those wishing to advertise products and services to as wide an audience as possible. A trend has developed where some parties which have been provided legitimately with contact details of prospective recipients for a particular use, pass on those details to other parties perhaps for profit or in exchange for details of other prospective recipients. The contact details, thus distributed, may be used by unwarranted distributors to send unsolicited communications. In some cases, such unsolicited communications are of interest to the recipients but for the most part, they are not. In any case, it is presently very difficult to trace the origin of a piece of correspondence to the particular distributor who gave away the recipient's contact details.

An associated and equally vexatious problem occurs when a consumer or citizen provides their contact details to a third part for an altogether different purpose—such as making a purchase. In such cases, subsequent correspondence from the third party may be unwanted.

This problem—that of receiving correspondence (so called “junk” mail and unsolicited “spam” mail) from distributors without having requested it—has become so commonplace that consumers and citizens alike are becoming reluctant to give out their contact details, even to distributors which might be of interest to them, for fear of receiving unsolicited correspondence from other distributors in which they are not. Furthermore, such consumers and citizens are becoming more likely to request that their contact details are withheld in circumstances where they would otherwise be available. This trend is providing a barrier to the free flow of desirable communication and interaction between distributors and prospective recipients, for the purposes of subscribing to those distributors and otherwise, to the detriment of all parties.

Several attempts have been made to address the problem of junk mail. Principally, these have focussed on identifying unsolicited correspondence, and preventing it from being received by the prospective recipients to whom it is directed. For example, postal services have been known to maintain a list of addresses to which unsolicited communications should not be delivered. However, this scheme is labour intensive for the services which operate it and does not, in any case, tackle the volume of junk mail being sent—only the volume being received.

In cases where physical intervention is not possible (for example where communication is automated, such as via telephony or the internet), two other solutions have been proposed. The first solution, alluded to above, is to withhold contact details from all distributors, such as by removing them from publicly available databases. This method is typically used with telephone directory services, for example, but cannot prevent third parties from obtaining contact details by other means, and fails to discriminate between distributors who might be of interest to the prospective recipient, and those who are not. The second solution is to attempt to recognise the content or the distributor of communications to establish whether the communication is solicited or not. This method has found particular application in email correspondence, for example, wherein emails may be filtered according to the sender or catchwords in the body of the email, such that unsolicited emails are not received by the recipient. However, this method may require the prospective recipient to indicate whether or not an email is junk mail, since the filtering system is not always effective. Furthermore, this solution suffers from the same problem as the postal services example above, insofar as resources have already been dedicated to processing the delivery of the unsolicited message by the time it is to be received.

What is needed, therefore, is a system and method which prevents unwarranted distributors from having access to contact details in the first place, and thereby enables people to provide contact details to distributors of interest with confidence that they will not subsequently receive unsolicited correspondence from parties whom they did not authorise.

In contrast to the prior art approaches described above, which address the problem of junk mail only by conceiving ways of preventing its receipt, the present invention proposes ways of preventing its dissemination, by removing the incentive for legitimate third parties to pass on prospective recipients' contact information to others, and thereby preventing such third parties from having access to it, and thereby preventing unsolicited communications from being sent in the first place.

### SUMMARY OF INVENTION

The present invention solves the above described problems by providing systems and methods which are capable of identifying the particular distributor which caused correspondence to be received by a recipient, regardless of which distributor sent the correspondence. In other words, the invention is capable of identifying correspondence received from any distributor as a consequence of a prospective recipient providing their contact details to one particular distributor. The systems and methods according to the invention allow the recipient to provide an evaluation of the correspondence received to thereby enable an assessment to be made of the one particular distributor to whom their contact details were given.

Thus, providing the particular distributor keeps the recipient's contact details private, and the recipient receives communications from only that distributor, for example, the feedback and the assessment of that particular distributor will be good. This will encourage other prospective recipients to agree to provide their contact details to that distributor. On the other hand, if the particular distributor sends junk mail, or sells or provides the contact details to other distributors who subsequently send junk mail or spam mail to the recipient, the feedback and assessment of that particular distributor will be bad. This will dissuade other prospective recipients from agreeing to provide their contact details to that distributor. Accordingly, distributors will have an incentive not to circulate contact information to others, which will lead to less junk mail being sent (and accordingly received).

In a first aspect, the present invention provides a method of assessing a distributor of correspondence, comprising: providing a unique address for receiving correspondence from the distributor; receiving an evaluation of the distributor based on the correspondence received at the unique address; and forming an assessment of the distributor based on the received evaluation.

In a second aspect, the present invention provides a system for assessing a distributor of correspondence, comprising: first processing means for generating a unique address for supplying to the distributor; and second processing means for receiving an evaluation of the distributor and forming an assessment of the distributor based on the received evaluation.

In a third aspect, the present invention provides a system for enabling a prospective recipient of correspondence to provide an evaluation of the distributor of said correspondence; comprising: a utility for obtaining a unique address to supply to the distributor for receiving correspondence there from; and a transmission facility for submitting an evaluation of the distributor based on correspondence received at the unique address.

In a fourth aspect, the present invention provides a method of providing an assessment of a distributor of correspondence, comprising: receiving an evaluation of the distributor from a recipient based on correspondence sent by the distributor to a unique address; forming an assessment of the distributor based on the received evaluation; and making the assessment available to a third party.

In a fifth aspect, the present invention provides a system for providing an assessment of a distributor of correspondence, comprising: first processing means for receiving an evaluation of the distributor based on correspondence received at a unique address and forming an assessment of the distributor based on the received evaluation; and second processing means for making the assessment available to a third party.

### BRIEF DESCRIPTION OF THE FIGURES

Embodiments of the invention will now be described in detail with reference to the following figures, in which:

FIG. 1 illustrates an embodiment of a method according to a first aspect of the invention;

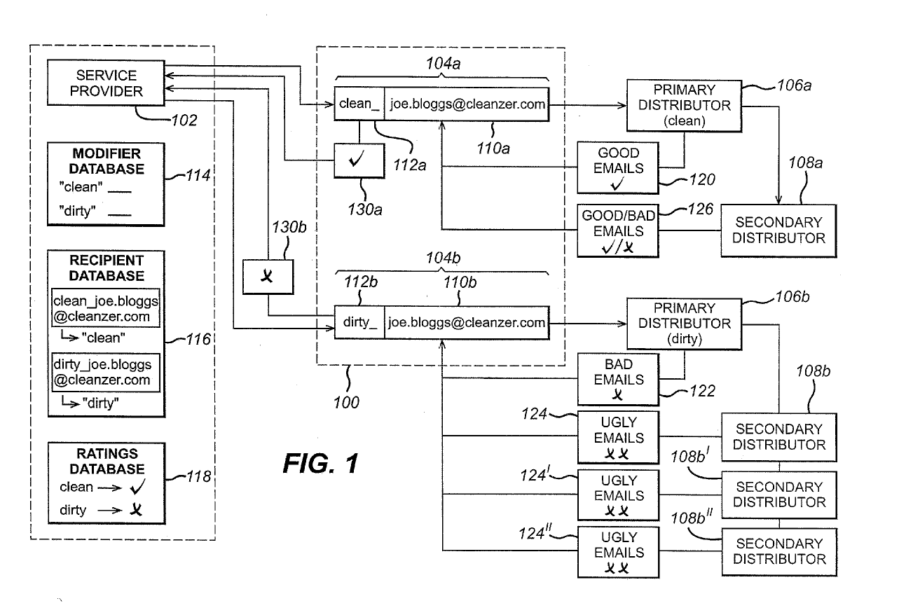

FIG. 2 illustrates an embodiment of a system according to a second aspect of the invention, said system implementing the method of FIG. 1;

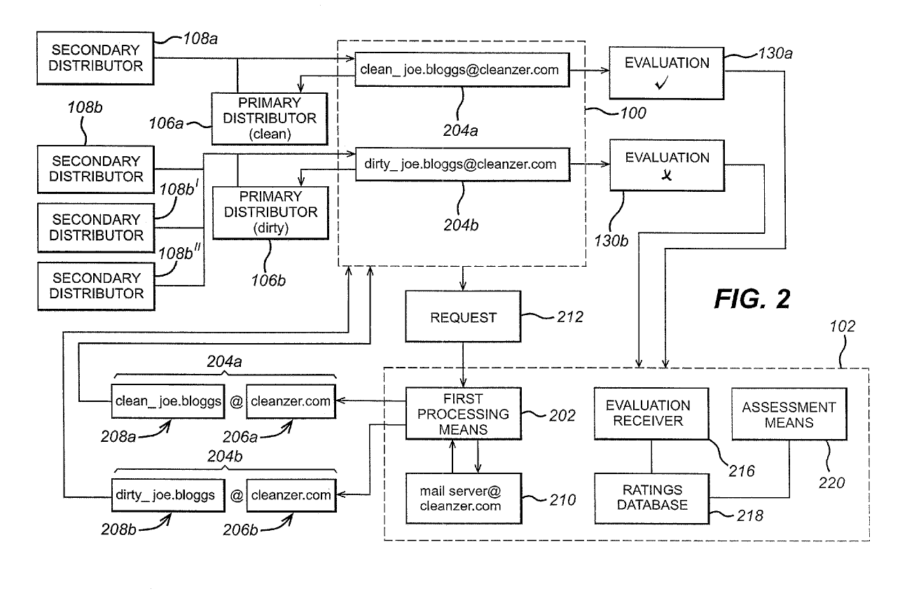

FIG. 3 illustrates a first environment in an embodiment of a system according to a third aspect of the invention; and

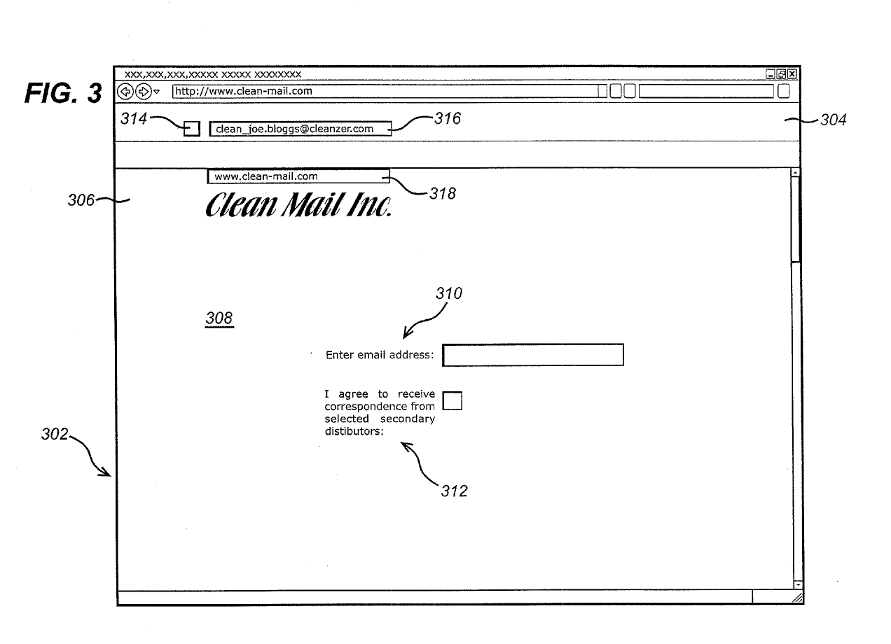

FIG. 4 illustrates a second environment in an embodiment of a system according to a third aspect of the invention.

### DETAILED DESCRIPTION OF INVENTION

In a preferred embodiment of the first aspect of the invention, realised in an internet context and with particular emphasis on email correspondence, a third party perhaps a primary distributor—may have a website which allows prospective recipients to provide an email address—perhaps to gain access to a service on offer from the third party, or perhaps to sign up for newsletters, advertisements, offers and/or the like from either the primary distributor and/or selected secondary distributors which are selected by the primary distributor, for example.

Throughout the application, the term “recipient” is used to refer to any person who has access to correspondence sent by a distributor and is able to provide an evaluation of the distributor based on the correspondence. The recipient need not be the person whom the distributor intended to receive the correspondence. The recipient may be a consumer who has provided their address to receive purchased goods from a supplier, which subsequently distributes correspondence to the address provided. Alternatively, the recipient may be an employee of a service provider, which may optionally be commissioned by a third party to have access to correspondence sent by a distributor to that third party.

Of course, the following embodiment is merely illustrative of the first aspect of the invention, which may be realised in other contexts. For example, a primary distributor may provide some other means for signing up to receive communications, and the address provided by the prospective recipient may be a postal address, with which to receive communication by mail; a fixed or cellular telephone number, with which to receive communication by SMS or telephone call; or an instant message (IM) alias or the like, with which to receive communication by any manner of known electronic means. The following references to the unique email address should be understood to be capable of substitution with anyone of the above means of communication or their equivalents.

In any case, a service provider 102 enacting a preferred embodiment of a method according the first aspect of the invention provides a potential recipient 100 with a unique email address 104. This email address is not the recipient's typical email address, but one created by the service provider especially for the purpose of receiving emails from one particular primary distributor 106 and/or selected secondary distributors 108 chosen by that one primary distributor 106. In other words, the unique email address 104 is only to be given once, to a single primary distributor 106, for the purpose of enabling the service provider 102 and the prospective recipient 100 to identify the primary distributor 106 responsible for any email received at that address 104, regardless of the sender. Any email received at the unique email address 104 will either be received because it was sent by the primary distributor 106, or because it was sent by a 10 secondary distributor 108 to whom the unique email address 104 was given by the primary distributor 106.

The unique email address 104 may be based, to at least some extent, on the composition of the recipient's existing email address. For example, the unique email address may be a concatenation of the recipient's existing email address 110 and a modifier 112 unique to the primary distributor 106. Such modifiers could be stored in a modifier relational database 114 operated by the service provider 102, for example, which provides a modifier 112 for each primary distributor 106 with whom a recipient wishes to sign up. New modifiers 112 might be created in circumstances where the primary distributor 106 is not known to the service provider 102. An identifier of primary distributors 106 might be stored in the modifier relational database 114 such that the primary distributor 106 is recognised by the service provider 102 upon receipt of a request from a prospective recipient 100 to be provided with a unique email address for use with that primary distributor 106. An identifier of the primary distributor might be the domain name, for example. This process is described in more detail in connection with the third aspect of the invention below.

In any case, if the recipient's existing email address 110 is “joe.bloggs@cleanzer.com”, for example, and the recipient wishes to sign up to receive emails from the primary distributor “Clean Mail Inc.” 106a having the unique modifier “clean” 112a, the unique email address 104a might be “cleanjoe.bloggs@cleanzer.com”.

Of course, the modifier 104 might be numeric, or a randomly assigned series of alpha-numeric characters, or the address need not be based on the existing email address at all. For example, it could simply be a randomly generated and produced alphanumeric address, in which case a modifier relational database may not be required. In preferred embodiments of the invention described in more detail below, it is not necessary for the email address to be semantic, or easy to remember since all further operations with the address, such as being provided to and associated with the primary distributor, may be carried out automatically by the service provider.

Combinations of these approaches allow the modifier to be based on the primary distributor, supplemented with alpha numeric characters (e.g. clean2621@cleanzer.com); on the recipient's name, supplemented with alpha numeric characters (e.g. joe.bloggs2621@cleanzer.com); or an alias selected by the recipient, supplemented with alpha numeric characters (e.g. tomboy2621@cleanzer.com). Many other mechanisms can of course be employed.

For each primary distributor 106a, 106b with whom the prospective recipient 100 intends to sign up, the service provider 102, in accordance with a method according to the first aspect of the invention, provides a unique email address 104a, 104b. In this way, the recipient 100 may elect to receive emails from any number of primary distributors 106a, 106b, and/or their respective secondary distributors 108a, 108b, whilst retaining the capability of identifying the primary distributor 106a, 106b responsible for every piece of email received by reference to the unique email address 104a, 104b to which that email is sent.

Once a unique email address 104 has been generated, the service provider 102 stores the email address 104 in a recipient relational database 116. The recipient relational database 116 creates and stores an association between each unique email address 104a, 104b, the primary distributor 106a, 106b to which that unique email 30 address 104a, 104b has been given and, optionally, details of the recipient, for use in later steps of this and other methods according to the invention. The primary distributor 106a, 106b may optionally be referred to by its unique modifier (112a, 112b).

Examples of the details of the recipient which might be stored in the recipient relational database 116 are the recipient's name, existing email address, postal or forwarding addresses, fixed or cellular telephone numbers, IM alias, passwords, bank account details and so on. Such details may be collected if the recipient were to register and/or create a user account with the service provider.

The recipient relational database may also be used to record information about a recipient's activity. Such details might include the primary distributors with whom the recipient signs up; the emails which the recipient reads and so on.

Once the unique email addresses 104 have been generated and supplied to primary distributors 106, they may be used in a number of ways. Firstly, an email address 104a may be used by a primary distributor 106a to send emails 120 which the recipient 100 intended for that primary distributor 106a to send. Such emails 120 are of interest to the recipient 100 and may be categorised as “good emails”. Of course, a primary distributor 106b may abuse his licence and use a recipient's email address 104b to send emails 122 in which the recipient 100 has no interest and are unwanted. These emails 122 may be categorised as “bad emails”. However, the primary distributor 106b may give away the recipient's email address 104b to secondary distributors 108b, 108b′, 108b″, who may send emails 124,124′, 124″ to the recipient 100 which the recipient did not intend to receive. Such emails 124, 124′, 124″ may be categorised as “ugly emails”. Of course, the recipient may have permitted the primary distributor 106a to give away the recipient's email address 104a to certain authorised secondary distributors 108a, in which case, emails 126 sent by such authorised secondary distributors 108a may be categorised as “good” or “bad”, as with those emails 120, 122 sent by primary distributors 106a, 106b. Emails from unauthorised secondary distributors 108b would always typically be categorised as “ugly”.

Another scheme would be to categorise all expected emails, such as order confirmations, and so on, as well as all emails to which the recipient subscribed and intends to receive from the primary distributor, as “good”; any unexpected or unwanted marketing emails the recipient did not intend to receive from the primary distributor as “bad” and any marketing received from third parties (i.e. junk mail) or unsolicited spam mail from secondary distributors as “ugly”. Alternatively, the scheme may distinguish between so called junk: mail and spam mail and categorise the two types of mail separately. It should be borne in mind that junk: mail may be sent by the primary distributor even if it originates from a secondary distributor.

Of course, the particular categorisation of emails may be tailored to particular circumstances or set according to the preference of the service provider 102 or the recipient 100. In any case, the categorisation should be capable of giving an indication of whether the behaviour of the distributor is positive, negative or one of any number of degrees in between.

The next step in a method according to the first aspect of the invention is for the service provider 102 to receive an evaluation 130 from the recipient 100 about primary distributors, based on emails received at the unique email addresses 104. The recipient 100 may provide an evaluation in a variety of ways which will be discussed at length below, in connection with an embodiment of the third aspect of the invention. For the time being, it is sufficient to understand that the evaluations 130 provide either positive or negative indications of each primary distributor 106 which may, for example, be in the form of a rating.

In any case, for the service provider 102, the evaluation requires both an indication and information identifying the primary distributor with which the indication is connected such that this data may be stored in a ratings relational database 118. In this preferred embodiment, the indication is sent with the respective unique email address 104a. By reference to the recipient relational database 116, which stores the associations between the unique email addresses 104 and the primary distributors 106, the indication may be associated with the appropriate primary distributor 106 in the ratings relational database 118. However, the indication may be sent by the recipient to the service provider in any manner, such as, but not limited to, those described below in connection with the second aspect of the invention. For example, an identifier of either the email being evaluated or the distributor may be used by the service provider.

The final step in a method according to the first aspect of the invention is to create an assessment of each primary distributor 106, based on the evaluations 130 received from the recipient 100. The assessment may be an average of the ratings, for example, or based on the number of positive and negative indications received from recipients. As more and more recipients 100 of emails from a particular primary distributor 106 submit evaluations 130 of that primary distributor 106 to the service provider 102, the calculated assessment of the primary distributor 106 in question becomes more and more indicative of its behaviour, as perceived by recipients 100 who have provided their email addresses to it.

Hence, if a primary distributor 106b sends nothing but bad emails 122 and gives away recipients' email addresses to secondary distributors 108b, 108b′, 108b″ who send ugly emails 124, 124′, 124″, the evaluations 130b submitted by the recipients 100 to the service provider 102 are very likely to give a negative indication or low rating of the primary distributor 106b. Accordingly, the calculated assessment of that primary distributor 106b will also be negative or low. Conversely, if a primary distributor 106a sends nothing but good emails 120, and gives away recipients' email addresses only to certain authorised distributors 108a who also send nothing but good emails 126, the evaluations 130a submitted by the recipients 100 to the service provider 102 are very likely to give a positive indication or high rating of the primary distributor 106a. Accordingly, the calculated assessment of that primary distributor 106a will also be positive or high.

As explained below in connection with a method and system according to fourth and fifth aspects of the invention, respectively, the calculated assessments may subsequently be distributed to third parties, who may use the assessments to decide whether or not to provide their contact details to primary distributors. In this way, a primary distributor 106 is given an incentive to behave well, and ensure its recipients 100 receive only good emails or face losing the opportunity to gain any new prospective recipients 100.

As mentioned above, methods according to the first aspect of the invention are not limited to internet contexts and email correspondence. For example, the aspect also encompass postal correspondence sent by mail, for example, a fixed or cellular telephone number, with which to receive communication by SMS or telephone call; or an instant message (IM) alias or the like, with which to receive communication by any manner of known electronic means. In all of these cases, the step of assigning a unique address is largely equivalent to that described above. Postal addresses, for example, may be supplemented with a bespoke address line containing an identifier of the primary distributor. Preferably, this identifier is encrypted so as to not be identifiable to the distributor. Alternatively, PO boxes or rented postal address may be used instead. A bank of telephone numbers may be obtained for a particular recipient, such that each may be given to a particular distributor. Calls to anyone of the bank of numbers may be redirected to the recipient's preferred number such that they may be received.

According to an embodiment of the second aspect of the invention, a system for performing the method of the first aspect is provided. As with the first aspect, the following embodiment is presented in an internet context, and with a particular emphasis on email correspondence. However, also as with the first aspect, systems according to the second aspect may be realised in other contexts, including post, fixed and cellular telephone communication including SMS, and instant messaging, as described in connection with the first embodiment.

A system according to an embodiment of the second aspect of the invention comprises first processing means 202 for generating a unique email address 204 for supplying to a primary distributor in the manner described above in connection with the first aspect of the invention. The unique email address 204 may take any of the forms described previously. An email address 204 may be created according to well known techniques familiar to a person skilled in email arts. Preferably, the unique email address 204 is formed of a common domain name 206 (the portion of the address after the ‘@’ sign) and a unique local part 208 (the portion of the address before the ‘@’ sign). Preferably, the service provider 102 operates a mail server 210 which maintains a particular domain name such that the first processing means 202 may easily create new unique email addresses 204 simply by creating new unique local parts 208. The local part 208 may take any of the forms described above in connection with the first aspect of the invention.

In the preferred embodiment described above, wherein the local part is a randomly generated and provided series of alphanumeric characters of a given length, the total number of unique addresses available is limited only by the capacity of the mail server to host those addresses at the particular domain name. Typically the capacity of such servers is several million addresses or more.

The unique email address 204 may be created by the service provider 102 upon receipt of a request 212 by the recipient 100. The receipt of the request 212 and the provision of an email address 204 may be channelled through a variety of means, as will be described in more detail in connection with the third aspect of the invention below. For the time being, it is sufficient to understand that, in the present embodiment, the prospective recipient 100 requests the service provider 102 to generate and provide the recipient 100 with a unique email address 204 such that the recipient may supply that email address to a primary distributor.

Once the recipient has been provided with the new unique email addresses 204 and has provided those unique email addresses 204 to primary distributors 106a, 106b as described above, it will begin to receive emails from those primary distributors 106a, 106b and/or respective secondary distributors 108a, 108b, 108b′, 108b″.

The system according to the present invention provides means 216 for receiving an evaluation of the primary distributors 106a, 106b from the recipient 100 based on emails received at the unique email addresses 204a, 204b. In the internet context, the evaluations 130a, 130b may be sent by email, or means may be provided for the recipient to send an evaluation in the form of a bespoke computer-implemented application, such as an application embedded within a webpage or an internet browser, for example. A cellular phone or PDA application may instead provide such a means for the recipient. In each case, the service provider will have corresponding means 216 in communication with one or more of the above facilities, via the internet, local or wide area network, GPRS, WAP or the like, to receive the evaluations 130 from the recipient 100. As explained above, the means 216 for receiving evaluations 130 may be coupled to a ratings relational database 218 such that the received evaluations 130 may be associated with the appropriate primary distributor 106.

Finally, once the service provider 102 has received a quantity of evaluations 130 about a particular primary distributor 106 from recipients 100, it may make use of means 220 for forming an assessment of the distributor 106 based on the received evaluations 130 stored in the ratings relational database 218. The complexity of the assessment may depend on the sophistication of the evaluations 130 sent by the recipients 100, as described in more detail in connection with the third to fifth aspects of the invention below.

In a preferred embodiment of a system according to the third aspect of the invention, again realised in an internet context, a prospective recipient 100 accesses an environment 300 provided by the service provider 102. The environment provides the prospective recipient 100 with the capability to interact with the service provider 102 to make use of the method and system described above in connection with the first and second aspects of the invention.

Of course, the environment 300 of this embodiment is merely illustrative of a system according to the third aspect of the invention, which may be realised in other contexts. For example, the environment 300 need not be provided in an internet setting, but may be provided instead as a paper based system implemented through the postal services. Alternatively, the environment might be provided on a fixed or cellular telephone, for example, in particular as an application for smart phones and the like.

In any case, the environment 300 implemented in a preferred embodiment of a system according to the third aspect of the invention provides a potential recipient 100 with a subscription toolbar 304, or other application embedded within an internet browser 302. Such a toolbar 304 may be downloaded, for example, from the service provider's website and used with any brand of internet browser. The browser may be used to interface with primary distributors 106, whose website 308 is shown in the browser's main window 306 in order to sign up to receive correspondence from those primary distributors 106 and/or selected secondary distributors 108.

At a point in the proceedings, the potential recipient may be confronted with a request 310 to provide an email address such that the primary distributor 106 may send correspondence to the recipient 100. The primary distributor may also request permission 312 to give away the recipient's email address to secondary distributors, such that they may send correspondence to the recipient 100.

At this point, the recipient may make use of an email address request facility 314 provided on the subscription toolbar 304, with which he may request a new unique email address from the service provider 102. The service provider will, having received the request (as described above in connection with the second aspect of the invention) generate a new unique email address and send it to the recipient (as described in connection with the first and second aspects of the invention). Once received, the environment 300 may display the new unique email address in a field 316 on the subscription toolbar 304. The recipient may then provide the new unique email address in response to the primary distributor's request 310 and indicate whether the primary distributor has authorisation to give away the unique email address to secondary distributors 312. The recipient may, for example, type in the unique email address in the appropriate field of the primary distributor's website 300. Alternatively, the recipient may use copy and paste facilities to copy the unique email address from the display and paste is in the field. In a preferred embodiment, the address field of the primary distributor's website may be populated automatically with the unique email address by the recipient selecting an option to populate the field following a right-click of a mouse. Of course, depending on the particular context in which the invention is realised, the unique address might be provided in different ways. It may be given at a website, from an application loadable on a personal computer or cellular phone, or the like and so on.

Upon executing the request facility 314, the subscription toolbar 304 may interrogate the website 308 of the primary distributor to obtain an identifier 318 of the website 308. Most conveniently, the identifier 318 is the domain of the website. This identifier may be sent to the service provider 102 along with the request to be provided with a unique email address, such that the service provider may attempt to look up the primary distributor 106 in its modifier relational database 114 in order to create a new unique email address 104 based on a concatenation of the modifier associated with that primary distributor 106 and the potential recipient's existing email address. Of course, if the identifier 318 is not recognised by the service provider 102, it may create a new entry in its modifier relational database, along with a new modifier for use with the unrecognised primary distributor. This process is described in more detail in connection with the first aspect of the invention above. Of course, as mentioned above, a randomly generated alphanumeric address may be provided without the need for a modifier relational database.

Once the prospective recipient 100 has provided the primary distributor with the unique email address 104, the recipient will begin to receive emails from the primary distributor 106 and/or secondary distributors 108 as those distributors use that address to send emails to the recipient. The manner in which emails are managed is described below.

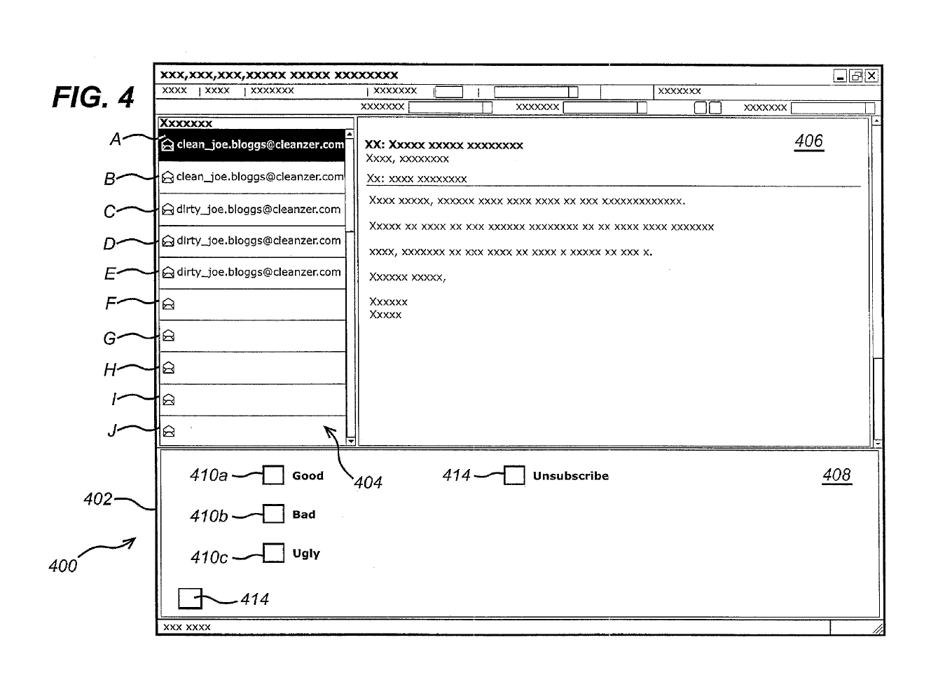

Another function of the same or an interconnected environment 400, according to a system according to the fourth aspect of the invention, is illustrated in FIG. 4. In the preferred embodiment, this environment is a webpage 402 operated by the service provider 102. The webpage gives the recipient 100 access to the emails sent to the unique email addresses 104. Preferably, the service provider 102 stores all such emails on its mail server 210 and allows the webpage 402 access to the emails on its mail server 210 for a particular recipient 100 in accordance with techniques known in the email arts. Alternatively, the environment 400 might be accessible in a bespoke application for a personal computer, PDA, smart phone or the like. Alternatively, the environment 400 might be configured to supplement existing email applications.

The webpage 402 could allow the recipient to review emails in a variety of ways. For example, emails received at each unique email address might be reviewed separately, or emails received at all unique email addresses might be reviewed together. Furthermore, the webpage 402 might manage the emails such that the recipient reviews all emails; only emails which have not yet been read; only email which have been read; emails received over different time periods (in particular the last day, two days, five days, week, two weeks, month, three months, year), emails which have and/or have not been categorised, and so on. The manner of display will be a preference for a user, and can therefore be set by the user.

As with typical email clients, the webpage 402 allows a recipient to forward delete and reply to emails.

In a particular embodiment, the webpage 402 comprises a list 404 of emails ‘A’ to ‘J’ received from primary and secondary distributors 106, 108. Optionally, the list indicates the primary distributor 106 responsible for the receipt of each email by reference to the unique email address 104 to which that email was sent. As shown in FIG. 4, emails ‘A’ and ‘B’ were received at the unique email address: clean joe.bloggs@cleanzer.com and, as a result, are the responsibility of the primary distributor Clean Mail, Inc. 106a whereas emails ‘C’ to ‘E’ were received at the unique email address: dirty joe.bloggs@cleanzer.com and, as a result, are the responsibility of the primary distributor Dirty Mail, Inc. 106b. The same is the case with emails ‘F’ to ‘J’, although the primary distributor is not indicated on the Figure.

The webpage 402 includes a window 406 in which the email contents may be reviewed by the recipient 100 upon selection of the appropriate email. Finally, the webpage 402 provides an evaluation pane 408 which is used by the recipient 100 to provide an evaluation of the primary distributor 106 and, optionally, manage subscriptions to that primary distributor 106.

In the preferred embodiment, for each received email in the list 402 the recipient 100 is provided with a facility to give an indication 410 pertaining to the quality of the email. In the present embodiment, the recipient 100 is given a list of three indications 410 corresponding to ‘good’, ‘bad’ and ‘ugly’. Once the recipient has made his indication 410, he makes use of means 412 for sending his evaluation to the service provider 102.

Optionally, the environments 300, 400 may only be available to recipients who register with the service provider 100 and/or create a user account. In such cases, the service provider 100 may store information about the recipient such as their name, existing email address, postal or forwarding addresses, fixed or cellular telephone numbers, IM alias, passwords, bank account details and so on. These details may be stored in the recipient relational database 116, for example. It may be of use to recipients who have an account with the service provider to be able to store and access such information at their convenience. For example, a recipient's user name and/or password might be stored to enable a user to log into an account with the service provider and/or a third party. Alternatively, a recipient's bank details and/or postal address might be stored to enable a user to provide these to a third party with ease when making a purchase from the third party.

The particular format of the evaluation may depend on particular circumstances. For example, the evaluation may be a simple positive or negative indication of the email and/or primary or secondary distributor. Alternatively, the evaluation may take the form of a short questionnaire or multiple choice list to glean indications for a plurality of categories. Such categories might include: the relevance of each email; how interesting each email was to the recipient; whether each email is good, bad or ugly; subjective assessments of the volume of emails received by from that primary distributor and/or secondary distributors, and so on. Alternatively, the evaluation may simply be a means by which the recipient may submit an indication in the form of a short description or review of the email and/or primary or secondary distributor.

As explained above in connection with the first and second aspect of the invention, the recipient's evaluation 130 may be sent to the service provider in a variety of ways. In the present illustrative embodiment, the evaluation 130 could be sent as an email, for example. In other embodiments of a system according to the third aspect of the invention, such as those realised in contexts other than the internet, the evaluation may be sent in other ways. For example, if the environment 400 were to be realised on a cellular telephone, for example, the evaluation 130 could be sent as an SMS message. Alternatively, if the environment were to be realised on paper, the evaluation 130 may be sent in the mail.

In a preferred embodiment, the recipient is given access to a variety of options for providing an evaluation. Depending on how the environments 300, 400 are accessed by the user (for example: using a personal computer, a fixed or cellular telephone or other form of mobile device, or on paper), these options may be made available in different ways. A bespoke utility may be provided for the recipient to input or select a distributor and submit an evaluation of that distributor in the form of one or more ratings, for example. The utility may be provided as a web page or via an embedded application within a webpage. Alternatively, the utility may be provided in a toolbar of an internet browser, or a bespoke application loadable by a personal computer or mobile device such as a smart phone or PDA, for instance. Alternatively the recipient may be able to submit an evaluation to the service provider as a message. The message might be a voice message via a fixed or cellular telephone; a text message sent by cellular telephone; an email or facsimile, a letter sent by post, or any other suitable means of communication. In a particular preferred embodiment, the service provider may embed means for providing an evaluation within the body of an email from the distributor, such that the recipient may simply forward or reply to the email to send it, along with the evaluation, to the service provider. Alternatively, the service provider might compile and distribute a digest of emails received from one or more distributors, and provide means for submitting evaluations for each, as described above. As will be appreciated, any form of evaluation provision is applicable.

Finally, the evaluation toolbar 408 of the preferred embodiment includes a facility 414 for preventing further emails from being received at a particular unique email address 104. If, for example, the recipient grows tired of receiving bad and/or ugly emails from the primary 106b and/or secondary 108b distributors, he may opt to cease receiving emails from them. Optionally, the user may elect to shut down the unique email address in question, such that the emails sent to that unique email addresses are rejected. Alternatively, the recipient may simply elect to unsubscribe with the effect that the service provider stops giving the recipient access to the emails sent to that unique email address 104b and thus prevent emails from the primary and/or secondary distributors who use that address being received by the recipient, although they will continue to be received by the service provider. The toolbar could furthermore include a facility to re-subscribe to a unique email address from which the recipient has unsubscribed. Providing the unique email address is not shut down, the service provider might allow access to the full history of emails received at that email address whilst the recipient has unsubscribed once a recipient re-subscribes.

Of course, evaluations need not be limited to an internet context and may be submitted using any means of communication, such as post, fixed or cellular telephone, SMS and so on.

According to embodiments of the fourth and fifth aspects of the invention, again realised in an internet context and based upon the embodiments described above in connection with the first to third aspects of the invention, the service provider generates an assessment of each of the primary distributors based on the evaluations received from the recipients at least. The service provider subsequently makes the assessments of the primary distributors available to the public. Of course, as with the first to third aspects, methods and systems according to the fourth and fifth aspects may be realised in other contexts, including post, fixed and cellular telephone communication including SMS, and instant messaging.

In embodiments according to fourth and fifth aspects of the invention, the service provider 102 receives the evaluations 130 sent by the recipients 100. As explained above in connection with the first and second aspects of the invention, the evaluations 130 may be stored in a ratings relational database 118 and associated with the primary distributor 106 to which each evaluation 130 refers. Based upon the evaluations 130 stored in the ratings relational database 118, the service provider generates an assessment of each primary distributor 106.

The format of the assessment may depend on the particular format of the evaluations sent by the recipients and may depend on particular circumstances. For example, if the evaluation is a simple positive or negative indication, the assessment may be a single number which represents a sum total of all the positive and negative indications (the positive indications representing an addition of 1 to the sum; the negative indications representing a subtraction of 1 from the sum, for example). Alternatively, if the evaluation takes the form of a short questionnaire or multiple choice list based on a plurality of categories, the assessment may be calculated based on an average for each particular category. As mentioned above in connection with the third aspect of the invention, such categories might include: the relevance of each email; how interesting each email was to the recipient; whether the emails were good, bad or ugly, and so on. The volume of emails received from that primary distributor and/or secondary distributors, and so on, may also be used in generating the assessment, as described in more detail below.

The assessment need not be based on evaluations from all recipients. Evaluations from particular recipients known for or suspected of inaccuracy or partiality might be weighted such that their evaluations count for less or simply disregarded, for example. On the other hand, ratings from employed staff might be weighted such that their evaluations count for more, for example. An assessment might be limited to a particular geographical region, or to a particular demographic of recipient. Other such categorisations may also be used.

In preferred embodiments, the assessments based on evaluations from recipients might be supplemented with additional data collated by the service provider. Such data may be combined with the evaluations from recipients to create an overall assessment of the primary distributor.

For example, the service provider might collate data about whether the domain name of a sender of an email to a unique address is the same as or different from the domain name for which that unique address was created. Alternatively, the service provider might collate data indicative of whether recipients read emails from a particular distributor, such as read/unread rates of emails from a particular distributor. Such information is helpful to supplement the evaluations provided by the recipients in order to generate a combined assessment of the distributor.

Other additional data upon which the service provider may rely might include the frequency of emails sent to a particular unique email address (and therefore linked to a particular primary distributor), the sizes of emails sent, the quality and/or relevance of the emails sent (judged based upon metadata contained in the emails, for example), the quantity of content provided, the quality and/or responsiveness of the distributor's customer service, the speed of delivery of the emails, the time of delivery of the emails; the rates of responses to the emails; the rates of de-subscription and re-subscription to a primary distributor; the rates of deletion of emails; the rates of reading of the emails; ratios of emails pertaining to marketing to emails pertaining to information (again, judged based upon metadata contained in the emails, for example); the quantity of adverts per email; the presence of viruses, malware or spamware in the emails, or links within the emails to phishing websites; the country of origin of emails; destinations of the same emails from a particular distributor, and so on.

Many of the factors above are subjective, and rely on the recipient to provide a qualitative assessment of the factor in question.

In cases where an assessment may be based on email content, the service provider might review the email to identify words and/or phrases used therein, and then refer to a database of known words, phrases and other indicators to attempt to determine the content, and thus the quality and/or relevance of the emails. Publicly available databases and/or services, such as SpamAssassin (http://spamassassin.apache.org), may be used for this purpose. Alternatively, the recipient may simply provide a qualitative indication, as described above.

The assessments may also be based on content beyond that in emails received from the primary distributor. For example, if the service provider is aware that the primary distributor is associated with a particular website which itself contains viruses, malware or spamware, or is a phishing website, the assessment may also take this into account.

The service provider might also store associations between a plurality of distinct website domains all of which are operated by the same distributor. In this case, an assessment made in connection with one of the web domains may affect assessments made in connection with the associated domains.

The service provider might also make a comparison between the sender of an email and known sources of spam or other undesirable senders of emails; a comparison between the content of an email and known patterns of words likely to be spam.

The service provider might also include a system based upon a neural network which monitors one or more of the above factors against the evaluations of the recipients to detect patterns in the emails indicative of bad or ugly emails. For example, if a particular volume of emails are evaluated as ugly by recipients and share a similar pattern of words, the service provider may use this information to identify other emails having similar patterns. In a particular example of a neural network used in this context, words or combinations of words in emails may be evaluated and compared with the evaluations given to those emails to develop an understanding of patterns of words used in good, bad and/or ugly emails. Thus, upon detection of the same words or combinations of words in new emails, the service provider may assign a higher probability to those new emails of having the same evaluation.

In a preferred embodiment, the service provider applies a two stage methodology to the generation of an assessment. The first stage involves collating data such as that mentioned above, including that from recipients' evaluations, and making a calculation based thereupon—preferably to generate a score with which to compare distributors; and the second stage involves normalising the score to provide a grade which is readily understandable to third parties. The data may be weighted, such that particular occurrences are treated more seriously than others by having a greater effect on the score.

In a specific example, the service provider operates on the premise that the recipient wishes to receive as few emails as possible. In this case, the service provider simply takes note of the volume of emails sent by a particular distributor to a specific email address over a period of one month (by counting, for example, or by receiving an evaluation from the recipient) and generates a score corresponding to the number of emails sent. In this case, the higher the score, the worse the assessment will be. The score may be normalised by attributing the distributor with a grade depending on the score. For instance, a score of less than 10 (corresponding to fewer than 10 emails) might attract grade ‘A’. A score of between 10 and 50 might attract grade ‘B’, and a score of more than 50 might attract grade ‘C’. Of course, there may be any number of different grades, which may take one of many different forms. An alternative grading system provides a number of symbols, the number being indicative of a rating. For example, the symbols might be stars or envelopes and the grading system might be adapted to show between 0 and 3 such symbols, depending on the grade. Other numbers of symbols may equally be employed.

The above example may be made more sophisticated by applying weights to the emails based on their quality. For example, based on the same premise, a ‘good’ email, may be given a weighting of ×1, in which case such emails would have the same effect on the score as those described above. Emails which are deemed ‘bad’ might have a weighting of ×10, in which case such emails would be ten times worse for a distributor's score than good emails. Ugly emails might have a weighting of ×30, in which case such emails would have a particularly negative effect on a distributor's score.

Continuing with the above example, if a service provider chose to operate on the premise that good emails were considered desirable, such emails may be given a weighting of ×0, in which case they would have no effect on the distributor's score. Alternatively, if it was considered that no more than a certain number of good emails per month should be received, the weighting might be replaced with a slightly more complex algorithm which applied a weighting of ×0 to good emails until the threshold had been passed, after which point a weighting of ×1 might be applied. Further thresholds may be applied such that weightings increase depending on the total number of emails sent.

In a different specific example, weightings might be applied depending on whether or not emails are read by the recipient. For example, a weighting of ×0.5 might be applied to any email which the recipient is inclined to read, whereas a weighting of ×2 might be applied to any email which the recipient is not inclined to read. Thus, emails which are not read will have four times the effect of emails which are read on a distributor's score.

Finally, other metrics might be used to adjust a distributor's score. For example, the calculation may rely on increased weightings in respect of emails containing a certain number or percentage of keywords associated with spam emails; or those which are sent from a known spam server.

If preferred, unique addresses established recently (i.e. within a predetermined time period such as 7 days, for example) may be discounted from contributing to the generation of an assessment if they do not provide an accurate representation of a distributor's behaviour.

Of course, it will be appreciated that many different forms of weighting and weighting values are applicable and that the specific examples discussed above are merely exemplary. In particular, the assessment may be based on any desired combination of two or more of the above described metrics, including a combination of all of the above described metrics.

As mentioned above, the assessment need not be based on evaluations from all recipients. Evaluations from particular recipients known for or suspected of inaccuracy or partiality might be weighted such that their evaluations count for less or simply disregarded, for example. This may particularly be the case where the factors under consideration are particularly subjective.

In the second stage, the service provider normalises the score calculated for a particular distributor and associates that distributor with a grade. Typically, such grades are relatively few in number such that they are easily understandable. For example, a preferred way in which a grade may be assigned is to place the distributors' scores in numerical order, and give one of four grades based on quartile rankings. Using symbols to refer to grades, a preferred embodiment is to assign 3 symbols to a distributor who is responsible for no ugly emails, and fewer than one bad email per month; 2 symbols to a distributor who is responsible for no ugly emails, and more than one bad email per month but fewer than one bad email per fortnight; 1 symbol to a distributor who is responsible for no ugly emails, and more than one bad email per fortnight but fewer than one bad email per week; and 0 symbols to a distributor who is responsible for any ugly emails or more than one bad email per week. Of course, other schemes may be used instead.

Once an assessment has been generated, the service provider 102 makes it available to the public. This may be done in a variety of ways. For example, the service provider may simply maintain a publicly available database which lists each primary distributor 106 and their respective assessment. In such an embodiment, the service provider might operate a website which allows a third party to search for a distributor of interest. Alternatively, the service provider might distribute the assessment to each primary distributor for them to distribute themselves, for example on their website. Alternatively, the toolbar 304 of the environment 300 according to the third aspect of the invention might include functionality which recognises an identifier 318 of a primary distributor 106, for example its domain name, retrieves an assessment associated with that primary distributor 106 and displays the assessment on the toolbar 304. In such cases, the toolbar might view an assessment based on their own evaluations only, or evaluations received from a particular class of recipients (based on geographical region or demographic, for example) or evaluations received from all recipients.

In a preferred embodiment, the service provider may include functionality which supplements search results provided by a search engine with assessments of distributors with which the search results are associated. For example, a distributor's grade may be shown next to its hyperlink on a search results page. This may be done in collaboration with the search engine or, alternatively, automatically by the environment 300, such as by the toolbar 304. As above, the assessment may be conveyed in any manner, including displaying the grade ascribed to the distributor using symbols.

In a particularly preferred embodiment, the service provider might provide alerts to users about primary distributors, via the toolbar 304. Such alerts may be based, for example, upon the received evaluations of some or more of the recipients of emails from that primary recipient. As described above, the alert may be based on a combination of received evaluations and additional data collated by the service provider. Alerts may also be provided in respect of distributors which the service provider is aware are unsafe. Such distributors might operate malware or phishing web sites, for example. Preferably, alerts will take the form of notices which are made visible in the toolbar 304, as soon as a recipient navigates to a webpage of that distributor. Alternatively, notices might pop up prompted by applications running in the background, or be presented via email.

Alerts may be provided in a variety of circumstances. The recipient may be alerted upon receipt of new emails received from primary and/or secondary distributors, for example, which may be filtered by the unique email address to which the email was sent or by the content of the email, for example. Furthermore, alerts might pertain to new and/or updated assessments of primary distributors from which the recipient receives correspondence. Finally, alerts might pertain to the amount of activity in respect of a particular distributor or unique email address, which may be filtered by timescale, for example. One instance of such an alert might be that a distributor had not sent any email for over a year.

As with the first to third aspects of the invention, the above described method and apparatus according to the fourth and fifth aspects of the invention need not be realised in an internet context, as described. For example, the assessments may be made available by post, fixed or cellular telephone, fax, email, SMS or other electronic form of communication.

As a result of the above described systems and methods of the invention, the service provider may draw up and distribute a code of good practice which indicates how distributors may achieve positive assessments and how to avoid negative ones. The code may indicate how to provide communications which recipients will intend to continue receiving and/or good customer service.

Furthermore, the systems and methods of the invention may lead to the provision of an indicator such as an award, certificate or mark of trust, signifying that a distributor has achieved a certain level of assessment. The indicator may be indicative of the positive behaviour of a distributor, for example. Such marks could be displayed on a website or other literature to be indicated to prospective recipients that the distributor may be trusted. Awards may be issued to distributors exercising best practice in their industry, for example.

The invention has been described by way of examples only, which are illustrative and are not intended to limit the scope of the invention as defined by the appended claims.

1. A method of assessing a distributor of correspondence, comprising:
providing a unique address for receiving correspondence from the distributor;
receiving an evaluation of the distributor based on the correspondence received at the unique address; and
forming an assessment of the distributor based on the received evaluation.

2. The method of claim 1, wherein the step of providing a unique address comprises:
generating a unique address to provide to the distributor; and
creating and storing in a relational database an association between the distributor and the unique address.

3. The method of claim 2, wherein the unique address is generated following receipt of a request from a recipient, the method further comprising providing the unique address to the recipient to provide to the distributor.

4. The method of claim 3, wherein the step of generating the unique address comprises:
identifying an existing address of the recipient; and
creating a new address, based on the composition of the existing address.

5. The method of claim 1, wherein the step of receiving the evaluation comprises:
receiving one or more ratings of the correspondence received at the unique address.

6. The method of claim 5, wherein each of the one or more ratings pertain to a particular category.

7. The method of claim 6, wherein the particular category is at least one of:
the interest of the correspondence;
the relevance of the correspondence;
whether the correspondence was solicited; and the quality of the customer service from the distributor.

8. The method of claim 5, wherein the one or more ratings pertain to a single piece of correspondence received at the unique address.

9. The method of claim 5, wherein the step of forming the assessment comprises:
collating each of the one or more ratings; and
performing a calculation on the one or more ratings to derive a score; and
normalizing the score to derive a grade for the distributor.

10. The method of claim 9, wherein the step of forming the assessment further comprises collating data about the distributor to supplement the one or more ratings;
wherein the calculation is based on the one or more ratings and the collated data.

11. The method of claim 10, wherein the collated data pertains to at least one of:
the volume of correspondence sent by the distributor;
whether the correspondence is read or unread; and
the content of the correspondence.

12. The method of claim 10, wherein the step of performing a calculation to derive a score comprises assigning a weighting to at least one of each of the one or more ratings and each of the collated data.

13. A system for assessing a distributor of correspondence, comprising:
a mail server for generating a unique address for supplying to the distributor; and
at least one of: a computer-implemented application, a cellular phone application and a PDA application for receiving an evaluation of the distributor and forming an assessment of the distributor based on the received evaluation.

14. The system of claim 13, wherein the mail server comprises:
an address generator for creating the unique address; and
a relational database for storing an association between the distributor and the unique address.

15. The system of claim 14, wherein the address generator is configured to generate a unique address upon receipt of a request from a recipient and provide the unique address to the recipient.

16. The system of claim 15, wherein the address generator comprises:
an address parser configured to parse an existing address of the recipient; wherein the address generator is configured to create a new address based on the composition of the address parsed by the address parser.

17. The system of claim 13, wherein the computer-implemented application, the cellular phone application and the PDA application is configured to receive one or more ratings of the correspondence received at the unique address.

18. The system of claim 14, wherein each of the one or more ratings pertain to a particular category.

19. The system of claim 18, wherein the particular category is selected from the group consisting of:
the interest of the correspondence;
the relevance of the correspondence;
whether the correspondence was solicited; and
the quality of the customer service from the distributor.

20. The system of claim 19, wherein the one or more ratings pertain to a single piece of correspondence received at the unique address.

21. The system of claim 17, wherein the computer-implemented application, the cellular phone application and the PDA application is configured to:
collate each of the one or more ratings;
perform a calculation on the one or more ratings to derive a score; and
normalize the score to derive a grade for the distributor.

22. The system of claim 21, wherein the computer-implemented application, the cellular phone application and the PDA application is configured to:
collate data about the distributor to supplement the one or more ratings;
wherein the calculation is based on the one or more ratings and the collated data.

23. The system of claim 22, wherein the collated data pertains to at least one of:
the volume of correspondence sent by the distributor;
whether the correspondence is read or unread; and
the content of the correspondence.

24. The system of claim 22, wherein the calculation to derive a score assigns a weighting to each of the one or more ratings and each of the collated data.

25. A system for enabling a prospective recipient of correspondence to provide an evaluation of a distributor of said correspondence comprising:
a utility for obtaining a unique address to supply to the distributor for receiving correspondence therefrom; and
transmission facility for submitting an evaluation of the distributor based on correspondence received at the unique address.

26. The system of claim 25, wherein the utility is configured to submit a request to a service provider to be provided with a unique address; and further comprises:
a display for indicating the details of the unique address received from the service provider.

27. The system of claim 25, wherein the utility is configured to submit an existing address of the recipient, wherein the unique address received from the service provider is based on the composition of the existing address.

28. The system of claim 25, wherein the transmission facility is configured to transmit of one or more ratings of the correspondence received at the unique address.

29. The system of claim 28, wherein each of the one or more ratings pertain to a particular category.

30. The system of claim 29, wherein the particular categories include at least one of:
the interest of the correspondence;
the relevance of the correspondence;
whether the correspondence was solicited; and
the quality of the customer service from the distributor.

31. The system of claim 28, wherein the one or more ratings pertain to a single piece of correspondence received at the unique address.

32. A method of providing an assessment of a distributor of correspondence, comprising:
receiving an evaluation of the distributor from a recipient based on correspondence sent by the distributor to a unique address;
forming an assessment of the distributor based on the received evaluation; and
making the assessment available to a third party.

33. The method of claim 32, wherein the assessment is made available following an attempt by the third party to interface with the distributor.

34. The method of claim 32, wherein the assessment is made available following a request from the third party to receive the assessment.

35. The method of claim 32, wherein the third party is the distributor and the assessment is made available following a request from the distributor to receive the assessment.

36. The method of claim 32, wherein the step of receiving the evaluation further comprises:
receiving one or more ratings of the correspondence received at the unique address.

37. The method of claim 36, wherein each of the one or more ratings pertain to a particular category.

38. The method of claim 37, wherein the particular categories include at least one of:
the interest of the correspondence;
the relevance of the correspondence;
whether the correspondence was solicited; and
the quality of the customer service from the distributor.

39. The method of claim 36, wherein the one or more ratings pertain to a single piece of correspondence received at the unique address.

40. The method of claim 36, wherein the step of forming the assessment comprises:
collating each of the one or more ratings; and
performing a calculation based on the one or more ratings to derive a score; and
normalizing the score to derive a grade for the distributor.

41. The method of claim 40, wherein the step of forming the assessment further comprises collating data about the distributor to supplement the one or more ratings;
wherein the calculation is based on the one or more ratings and the collated data.

42. The method of claim 41, wherein the collated data pertains to at least one of:
the volume of correspondence sent by the distributor;
whether the correspondence is read or unread; and
the content of the correspondence.

43. The method of claim 41, wherein the step of performing a calculation to derive a score comprises assigning a weighting to each of the one or more ratings and each of the collated data.

44. A system for providing an assessment of a distributor of correspondence, comprising:
a mail server for receiving one or more evaluations of the distributor based on correspondence received at a unique address and forming an assessment of the distributor based on the one or more received evaluations; and
at least one of the following: a computer-implemented application, a cellular phone application and a PDA application for making the assessment available to a third party.

45. The system of claim 44, wherein the one or more received evaluations of the distributor comprises one or more ratings of the correspondence received at the unique address.

46. The system of claim 45, wherein the mail server comprises a relational database to store the one or more received evaluations.

47. The system of claim 46, wherein the mail server is configured to form the assessment by performing a calculation based on the one or more ratings and normalize the score to derive a grade for the distributor.

48. The system of claim 47, wherein the mail server is configured to:
collate data about the distributor to supplement the one or more ratings;
wherein the calculation is based on the one or more ratings and the collated data.

49. The system of claim 48, wherein the collated data pertains to at least one of:
the volume of correspondence sent by the distributor;
whether the correspondence is read or unread; and
the content of the correspondence.

50. The system of claim 48, wherein the calculation to derive a score assigns a weighting to each of the one or more ratings and each of the collated data.

51. The system of claim 44, wherein the computer-implemented application, the cellular phone application and the PDA application comprises:
a website and toolbar configured to receive a request to be provided with the assessment from a third party; and
alerts configured to send the assessment to the third party upon receipt of a request.

52. The method of claim 1 wherein the correspondence is email.

53. The system of claim 13 wherein the correspondence is email.

54. The system of claim 25 wherein the correspondence is email.

55. The method of claim 32 wherein the correspondence is email.

56. The method of claim 44 wherein the correspondence is email.
